(19) United States
(12) Patent Application Publication
(10) Pub. No.: US 2024/0246294 A1
(43) Pub. Date: Jul. 25, 2024

(54) METHOD FOR MANUFACTURING A COATED OBJECT

(71) Applicant: OECHSLER AG, Ansbach (DE)

(72) Inventors: Christian Fischer, Merkendorf (DE); Benedikt Santuens, Nuernberg (DE)

(21) Appl. No.: 18/416,009

(22) Filed: Jan. 18, 2024

(30) Foreign Application Priority Data
Jan. 19, 2023 (DE) 10 2023 101 333.5

(51) Int. Cl. B29C 64/30; B29C 35/02; B33Y 40/20; C09D 175/04; B29K 75/00

(52) U.S. Cl. CPC B29C 64/30; B29C 35/02; B33Y 40/20; C09D 175/04; B29K 2075/00

(57) ABSTRACT

A method for manufacturing a coated object, in which a partially cured intermediate object formed from a dual-curable material is formed by an additive manufacturing method, in which at least some regions of the partially cured intermediate object are coated with a coating material and in which the partially cured intermediate object is completely cured in a curing step to form the object. In one aspect, a polyurethane resin is used as the dual-curable material.

### CROSS-REFERENCE TO RELATED APPLICATIONS

The present application is based upon and claims the right of priority to German Patent Application No. 10 2023 101 333.5, filed Jan. 19, 2023, the disclosure of which is hereby incorporated by reference herein in its entirety for all purposes.

### FIELD OF THE INVENTION

The present subject matter relates generally to additive manufacturing and, in particular, methods for manufacturing additively manufactured elastic objects with coatings.

### BACKGROUND OF THE INVENTION

One group of additive manufacturing techniques, which is often referred to as “stereolithography,” generates a three-dimensional object via the sequential polymerization of a photopolymerizable resin. Such techniques can be “bottom-up” techniques, in which light is projected through a light-permeable window into the resin onto the bottom of the growing object, or “top-down” technologies, in which light is projected onto the resin on the top side of the growing object, the object then being dipped downward into the resin pool.

The recent introduction of a faster stereolithography technique, which is often referred to as Continuous Liquid Interface Production (CLIP), has expanded the usability of stereolithography from prototyping to production.

Dual-curing resins for additive manufacturing were introduced shortly after the introduction of CLIP, which even further expanded the usability of stereolithography for producing a wide variety of objects.

The introduction of CLIP, the introduction of dual-curing resins (which are also referred to as dual-cure resins), and the recognition of the variety of objects which can be suitably manufactured therewith has created a demand for new techniques for providing such objects with functional surface coatings.

U.S. Pat. No. 11,027,487 B2 describes a method in which stereolithographically produced intermediate objects made of cyanate ester dual cure resin or epoxy dual cure resin are coated with particles. The particles adhere on uncured polymerizable material which, when heated, exudes on the surface of the intermediate object.

The manufacturing method described in U.S. Pat. No. 11,027,487 B2 is limited to cyanate ester dual cure resin or epoxy dual cure resin, which are characterized first and foremost by their high strength and hardness after completely curing.

### BRIEF SUMMARY OF THE INVENTION

In various aspects, the present subject matter relates to a method for manufacturing a coated object, in which a partially cured intermediate object made of a dual-curable material is formed by means of an additive manufacturing method.

In the method, at least some regions of the partially cured intermediate object are coated with a coating material, in particular a pulverous coating material. Properties or surface properties can be imparted to the object by means of the coating material.

Moreover, in the method, the partly cured intermediate object is completely cured in a curing step to form the object. In so doing, a layer of the coating material is also formed.

In one embodiment, a polyurethane resin is used as the dual-curable material.

It is also advantageous when the coating material is arranged in a residual layer of uncured, dual-curable material on a surface of the partially cured intermediate object.

It is also extremely advantageous when the uncured, dual-curable material forming the residual layer is applied on the surface during the additive manufacturing method or remains on the surface after the additive manufacturing method. Additionally or alternatively, the uncured, dual-curable material forming the residual layer can be applied on the surface after the additive manufacturing method.

It is advantageous when the partially cured intermediate object is cleaned before the partially cured intermediate object is coated with the coating material such that the residual layer of the uncured, dual-curable material remains.

It is also advantageous when the cleaning of the partially cured intermediate object and/or the coating takes place after the additive manufacturing method and/or prior to the curing step, so that the residual layer remains.

It is particularly advantageous when the additive manufacturing method is carried out by means of light input and/or when the curing step is carried out by means of heating to at least one curing temperature.

Moreover, it is advantageous when a thermoplastic is used as the coating material, the thermoplastic having a melting temperature which is preferably higher than the at least one curing temperature in the curing step or which is preferably equal to or less than the at least one curing temperature in the curing step.

It is also advantageous when the additive manufacturing method, the coating, the curing step, and/or the cleaning are/is carried out multiple times.

It is additionally advantageous when, in particular, the curing step is carried out such that a bonded connection is formed between the coating material and the uncured, dual-curable material in the residual layer.

It is also extremely advantageous when, in particular, the curing step is carried out such that the coating material is partially or completely integrally incorporated into the existing network of the polymerizing, uncured, dual-curable material partially or completely at the molecular level.

In one aspect, the present subject matter further relates to an object which is manufactured according to one or more of the method steps mentioned in the preceding description and/or the following description.

Moreover, it is advantageous when a bonded connection or a boundary layer is formed between the coating material and the uncured, dual-curable material in the residual layer.

It is also advantageous when the object is elastic.

In one aspect, the present subject matter relates to a method for manufacturing an elastic object, wherein an intermediate object made of dual-curing polyurethane resins is additively manufactured. The method including the following steps:
If necessary, cleaning the partially cured intermediate object of excess uncured polymerizable material, such that, after cleaning, a residual layer of uncured polymerizable material remains on the surface of the intermediate object,
coating the intermediate object with coating material, in particular particles,
curing, in particular by heating, the partially cured intermediate object with the coating in order to completely cure the intermediate object, such that the object is formed.

In one embodiment, the coating is thermoplastic particles and the manufacturing method including the following steps:
additively manufacturing an elastic, green, partially cured intermediate object made of a dual-curing, polymerizable polyurethane resin, the intermediate object containing uncured polymerizable material; if necessary, cleaning the intermediate object, wherein a residual layer remains on the surface; coating the intermediate object with coating material, in particular with thermoplastic particles, the coating material, in particular the thermoplastic in powder form, being applied at least on a surface section of the partially cured intermediate object. Thereafter, the coated, partially cured intermediate object is cured, in particular heated, in order to form the object and set the final mechanical properties. In the process, the polymerizable material which has not been cured or the uncured dual-curing material is polymerized and bonds the coating material, in particular the thermoplastic particles. The melting temperature of the coating material, in particular of the thermoplastic, is higher than a curing temperature which is used for curing the partially cured intermediate object. Therefore, the coating material, in particular the thermoplastic particles, is/are incorporated differently into the existing network of the polymerizing material. If the melting temperature of the coating material, in particular of the thermoplastic particles, is below the curing temperature which will be required, the previously incorporated, in particular thermoplastic, coating material melts simultaneously or nearly simultaneously with the polymerization of the material which has not yet cured, such that the coating material, in particular the thermoplastic, is partially or completely integrally incorporated into the existing network of the polymerizing material partially or completely at the molecular level.

For the sake of completeness, it is mentioned that the aforementioned surfaces are not only closed surfaces, but also open surfaces, such as a strut structure or also a lattice structure.

One advantage of the present subject matter is that the object continues to behave elastically after the coating process according to aspects of the present subject matter.

The individual method steps are described in greater detail in the following.

### BRIEF DESCRIPTION OF THE DRAWINGS

Further advantages of the invention are described in the following exemplary embodiments, wherein:

FIG. 1 shows a schematic sectional view of an object during manufacture.

### DETAILED DESCRIPTION OF THE INVENTION

Dual-curing resins, which are also referred to as dual-cure resins or two-component resins, are known for additive manufacturing and are described, for example, in U.S. Pat. No. 9,676,963 B2, U.S. Pat. No. 9,598,606 B2 or U.S. Pat. No. 9,453,142 B2.

In accordance with aspects of the present subject matter, a dual-curing polyurethane resin is used, as a result of which elastic objects can be additively manufactured. Dual-curing polyurethane resins are characterized in that they are formed from heat-polymerizable components and from photopolymerizable components which undergo photopolymerization during the additive manufacturing in order to form a three-dimensional “green” intermediate object.

Further processing steps, for example, a cleaning process, can be carried out prior to and after the processing step of the heat polymerization.

Examples of dual-curing polyurethane resins are:
decanedioic acid, 1,10-bis(1,2,2,6,6-pentamethyl-4-piperidinyl)ester, decanedioic acid, 1-methyl10-(1,2,2,6,6-pentamethyl-4-piperidinyl)ester, diethylene glycol methyl ether methacrylate, diphenyl(2,4,6-trimethylbenzoyl)phosphine oxide, methacrylic acid dodecyl ester, polyethylene glycol dimethacrylate
2, 2′-dimethyl-4,4′-methylenebis(cyclohexylamine)
diethylene glycol methyl ether methacrylate, diphenyl(2,4,6-trimethylbenzoyl)phosphine oxide, diurethane dimethacrylate, isobornyl methacrylate, methacrylic acid-dodecyl ester, propoxylated neopentyl glycol diacrylate ester
2, 2′-dimethyl-4, 4′-methylenebis(cyclohexylamine), poly(oxypropylene)diamine, trimethylolpropane poly(oxypropylene)triamine
diethylene glycol methyl ether methacrylate, exo-1,7,7-trimethylbicyclo [2.2.1]-hept-2-yl methacrylate, ethylene glycol dimethacrylate, diphenyl(2,4,6-trimethylbenzoyl)phosphine oxide, trimethylolpropane triacrylate
2, 2′-dimethyl-4,4′-methylenebis(cyclohexylamine)
diphenyl(2,4,6-trimethylbenzoyl)phosphine oxide, polyethylene glycol dimethacrylate, polyurethane, methacrylate-blocked, trimethylolpropane triacrylate, trimethylolpropane trimethacrylate
2,2′-dimethyl-4,4′-methylenebis(cyclohexylamine)
diethylene glycol methyl ether methacrylate, ethyl phenyl(2,4,6-trimethylbenzoyl)phosphinate, trimethylolpropane triacrylate
2, 2′-dimethyl-4, 4′-methylenebis (cyclohexylamine), oxirane, methyl-, polymer with alpha-hydro-omega-hydroxypoly(oxy-1,4-butanediyl), bis(2-aminomethylethyl)ether, trimethylolpropane poly(oxypropylene)triamine

A variety of additive manufacturing methods are known. Suitable methods include bottom-up or top-down additive manufacturing, generally known as stereolithography. Such methods are known and described, for example, in U.S. Pat. Nos. 5,236,637 B2, 5,391,072 B2 and 5,529,473 B2, 7,438,846 B2, 7,892,474 B2, 8,110,135 B2, US 2013/0292862 A1 and US 2013/0295212 A1.

In some embodiments, the manufacturing step is carried out by means of bottom-up stereolithography (for example, continuous liquid interface production).

In some embodiments, the intermediate object is formed by means of continuous liquid interface production (CLIP). CLIP is known and described, for example, in U.S. Pat. Nos. 9,211,678 B2; 9,205,601 B2 or 9,216,546 B2.

If necessary, “green” objects or the partially cured intermediate objects, as described above, can be cleaned, such as, for example, by wiping (using a rigid or flexible wipe, substance or compressed gas, such as compressed air), washing, centrifugation, contact with an absorbent material (for example, absorbent pads or wipes, granular absorbent materials, such as those including diatomaceous earth and/or montmorillonite clay) or combinations thereof. Washing liquids which can be used to carry out the present subject matter include water, organic solvents and combinations thereof (for example, combined as cosolvents), but are not limited thereto, optionally containing additional components such as surfactants, complexing agents (ligands), enzymes, borax, dyes or coloring agents, fragrances, etc., including combinations thereof. The washing liquid can be present in any suitable form, such as a solution, emulsion, dispersion, etc.

A milder washing liquid can be selected depending on factors such as the combination of techniques selected for the cleaning step, the duration and/or temperature of the contact of the object with any type of washing liquid which can be used, and the like, in order to avoid excessively depleting the green object of polymerizable components, which can otherwise be used advantageously for adhering the coating.

The advantageous cleaning step after the manufacture of the partially cured intermediate object is characterized in that excess uncured polymerizable material is removed from the dual-curing material, although such that, after cleaning, a residual layer formed from uncured polymerizable material or uncured, dual-curing material remains on the surface or surface sections of the partially cured intermediate object, on which the coating material, in particular particles, can remain adhered.

The layer of uncured polymerizable material which is to remain on the surface of the partially cured intermediate object for subsequent coating is preferably in a range from 0.001 mm to 0.1 mm.

In some exemplary embodiments, there are also surfaces of the partially cured intermediate object, which are not to remain uncoated in the next step. These are completely cleaned, such that a residual layer of uncured, polymerizable material does not remain on the selected surfaces of the partially cured intermediate object.

Therefore, partially cured intermediate objects, after cleaning, can have surfaces without uncured, polymerizable material and surfaces with uncured, polymerizable material. There are multiple possibilities for achieving this. A few of the possibilities are briefly explained.

The surfaces are cleaned using the same cleaning technique. The intensity of the cleaning technique, for example, with respect to duration, washing medium, concentration of washing agent, etc., is appropriately varied in order to completely clean the surface of uncured, polymerizable material or to adapt the layer thickness of the uncured, polymerizable material.

Alternatively or additionally, different cleaning techniques can also be selected in order to obtain surfaces with uncured, polymerizable material and without uncured, polymerizable material. For example, surfaces which are to retain a residual layer of uncured, polymerizable material after cleaning can be cleaned by being blown off. Surfaces which are not to have any uncured, polymerizable material on the surface after cleaning can be cleaned, for example, with a liquid washing agent having a sufficient concentration of washing agent.

Alternatively or additionally, multiple cleaning techniques can also be applied in order to achieve the desired result on the surfaces.

Surfaces which are not to be cleaned in a cleaning step can be covered for protection during cleaning. Foils made, for example, of aluminum, plastic, fabric, etc., can be used for this purpose. Specifically contoured shapes or masks can also be applied here as well.

Due to the fact that the cleaning step leaves a residual layer of uncured, polymerizable material on the surface of the partially cured intermediate object, an adhesive does not need to be applied in a subsequent process step. Doing so would risk the adhesive influencing the curing process of the partially cured intermediate object.

For example, washing liquids consisting of isopropanol can be diluted with propylene glycol (for example, up to 30, 40, 50 or 60 percentage by weight) in order to provide a less aggressive washing liquid, or the washing liquid can consist entirely or nearly entirely of propylene glycol (for example, at least 70, 80 or 90 percentage by weight). When a washing liquid is not used (i.e., the cleaning step is carried out entirely by wiping, blowing off and/or contacting with an absorbent material), the aggressiveness of the washing liquid is not a problem.

When the cleaning step provides the surface of the object with components which are not desired to be introduced into the coating and/or a further curing step (such as, for example, from a particle absorbent and/or a washing liquid), some embodiments can include following the cleaning step with a further rinsing step (for example, using distilled and/or deionized water), a wiping step and/or a blowing-off step.

Examples of organic solvents which can be used as washing liquid or as a component of a washing liquid include, among other things, alcohol, esters, dibasic esters, ketone, acid, aromatic, hydrocarbon, ethers, dipolar aprotic, halogenated and basic organic solvents, including combinations thereof. Solvents can be selected in part based on their effects on the environment and health (see, for example, GSK Solvent Selection Guide 2009).

Examples of organic alcoholic solvents which can be used in accordance with aspects of the present subject matter include, but are not limited to, aliphatic and aromatic alcohols, such as 2-ethyl hexanol, glycerin, cyclohexanol, ethylene glycol, propylene glycol, dipropylene glycol, 1,4-butandiol, isoamyl alcohol, 1,2-propanediol, 1,3-propanediol, benzyl alcohol, 2-pentanol, 1-butanol, 2-butanol, methanol, ethanol, t-butanol, 2-propanol, 1-propanol, 2-methoxy ethanol, tetrahydrofuryl alcohol, benzyl alcohol, etc., including combinations thereof. In some embodiments, an aliphatic C1-C6 or C1-C4 alcohol is preferred. Examples of organic ester solvents which can be used to carry out the present subject matter include, but are not limited to t-butyl acetate, n-octyl acetate, butyl acetate, ethylene carbonate, propylene carbonate, butylene carbonate, glycerol carbonate, isopropyl acetate, ethyl lactate, propyl acetate, dimethyl carbonate, methyl lactate, ethyl acetate, ethyl propionate, methyl acetate, ethyl formate, etc., including combinations thereof.

Examples of dibasic organic ester solvents include dimethyl esters of amber acid, glutaric acid, adipic acid, etc., including combinations thereof, but are not limited thereto. Examples of organic ketone solvents which can be used to carry out the present subject matter include, but are not limited to, cyclohexanone, cyclopentanone, 2-pentanone, 3-pentanone, methyl isobutyl ketone, acetone, methyl ethyl ketone, etc., including combinations thereof.

Examples of acidic organic solvents which can be used for carrying out the present subject matter include, but are not limited to, propionic acid, acetic acid hydride, acetic acid, etc., including combinations thereof. Examples of aromatic organic solvents which can be used for carrying out the present subject matter include mesitylene, cumene, p-xylene, toluene, benzene, etc., but are not limited thereto.

Examples of hydrocarbon (i.e., aliphatic) organic solvents which can be used for carrying out the present subject matter include, but are not limited to, cis-decalin, ISOPA™ G, isooctane, methylcyclohexane, cyclohexane, heptane, pentane, methylcyclopentane, 2-methylpentane, hexane, gasoline, etc., including combinations thereof.

Examples of organic ether solvents which can be used for carrying out the present subject matter include, but are not limited to, di(ethylene glycol), ethoxy benzene, tri(ethylene glycol), sulfolane, DEG monobutyl ether, anisole, diphenyl ether, dibutyl ether, t-amyl methyl ether, t-butyl methyl ether, cyclopentyl methyl ether, t-butyl ethyl ether, 2-ethyl tetrahydrofuran, diethyl ether, bis(2-methoxyethyl)ether, dimethyl ether, 1,4-dioxane, tetrahydrofuran, 1,2-dimethoxy ethane, diisopropyl ether, etc., including combinations thereof.

Examples of dipolar aprotic organic solvents which can be used for carrying out the present subject matter include, but are not limited to, dimethyl propylene urea, dimethyl sulfoxide, formamide, dimethyl formamide, n-methyl formamide, n-methyl pyrrolidone, propane nitrile, dimethyl acetamide, acetone nitrile, etc., including combinations thereof.

Examples of halogenated organic solvents which can be used for carrying out the present subject matter include 1,2-dichlorobenzene, 1,2,4-trichlorobenzene, chlorobenzene, trichloroacetonenitrile, chloroacetic acid, trichloroacetic acid, perfluoretolulene, perfluorocyclohexane, carbon tetrachloride, dichloromethane, perfluorohexane, fluorobenzene, chloroform, cyclic perfluoroether, trifluoroacetic acid, trifluoro toluene, 1,2-dichloroethane, 2,2,2-trifluoroethanol, etc., including combinations thereof.

Examples of basic organic solvents which can be used for carrying out the present subject matter include N,N-dimethylaniline, triethylamine, pyridine, etc., but are not limited thereto.

Examples of other solvents which can be used for carrying out the present subject matter include, but are not limited to, nitromethane, carbon disulfide, etc., including combinations thereof.

Examples of surfactants include anionic surfactants (for example, sulfates, sulfonates, carboxylates and phosphate esters), cationic surfactants, zwitterionic surfactants, non-ionic surfactants, etc., including combinations thereof, but are not limited thereto. Examples include sodium stearate, linear alkylbenzene sulfonates, lignosulfonates, fat alcohol ethoxylates, alkylphenol ethoxylates, etc., including combinations thereof, but are not limited thereto.

Examples of complexing agents (chelating agents) include ethylenediaminetetraacetic acid, phosphates, nitrilotriacetic acid (NTA), citrates, silicates and polymers of acrylic acid and malic acid, but are not limited thereto.

Examples of enzymes which can be contained in the washing liquid include, among other things, proteases, amylases, lipases, cellulases, etc., including mixtures thereof.

In some embodiments, the washing liquid can be an aqueous solution of ethoxylated alcohol, sodium citrate, tetrasodium-N, N-bis(carboxymethyl)-L-glutamate, sodium carbonate, citric acid and an isothiazolinone mixture. A specific example thereof is SIMPLE GREEN® all-purpose cleaner (Sunshine Makers Inc., Huntington Beach, CA, USA), which is used as-is or is mixed with additional water.

In some embodiments, the washing liquid can be an aqueous solution which includes 2-butoxyethanol, sodium metasilicate and sodium hydroxide. A specific example thereof is the PURPLE POWE™ degreaser/cleaner (Alken Chemical Co., Greenville, S. C., USA), which is used as-is or is mixed with additional water.

In some embodiments, the washing liquid can be ethyl lactate alone or with a cosolvent. One specific example thereof is the solvent exchange BIO-SOLV™ (Bio Brands LLC, Cinnaminson, NJ, USA), which is used as-is or is mixed with water.

In some embodiments, the washing liquid consists of a 50:50 (volume:volume) solution of water and an organic alcohol solvent, such as isopropanol (2-propanol).

Examples of fluorocarbon solvents which can be used for carrying out the present subject matter include, but are not limited to, 1,1, 1,2,3,4,4,5,5,5-decafluoropentane (Pertrel® XF, DuPont™ Chemours), 1,1,1,3,3-pentafluoropropane, 1,1,1,3,3-pentafluorobutane, etc.

Examples of hydrochlorofluorocarbon solvents which can be used for carrying out the present subject matter include 3,3-dichloro-1,1,1,2,2-pentafluoropropane, 1,3-dichloro-1,1,2,2,3-pentafluoropropane, 1,1-dichloro-1-fluoroethane, etc., including mixtures thereof.

Examples of hydrofluoroether solvents for carrying out the present subject matter include methyl nonafluorobutyl ether (HFE-7100), methyl nonafluoroisobutyl ether (HFE-7100), ethyl nonafluorobutyl ether (HFE-7200), ethyl nonafluoro isobutylether (HFE-7200), 1, 1,2,2-tetrafluoroethyl-2,2,2-trifluoroethyl ether, etc., including mixtures thereof, but are not limited thereto. Commercially available examples of this solvent include Novec 7100 (3M), Novec7200 (3M).

Examples of volatile methylsiloxane solvents which can be used for carrying out the present subject matter include, among other things, hexamethyldisiloxane (OS-10, Dow Corning), octamethyltrisiloxane (OS-20, Dow Corning), decamethyltetrasiloxane (OS-30, Dow Corning), etc., including mixtures thereof.

In the coating step, the partially cured intermediate object is coated with a coating material, wherein a residual layer of uncured, polymerizable material is located on the entirety of or selected surface sections of the surface of the partially cured intermediate object. In one embodiment, the coating material includes particles, preferably with thermoplastic particles.

A plurality of different coating materials, in particular pulverous thermoplastics, can be used for the surface coating. All thermoplastics, such as, for example, PA, PE, PP, TPU, PEEK, PPSU, etc., can be used as basic plastics and also in combination therewith.

In some embodiments the coating material, in particular the thermoplastic, also includes additives which provide the coating material, in particular the thermoplastics, with additional properties. These additional properties are, for example:
flame retardant effect by, for example, antimony trioxide
electric discharge by, for example, carbon nanotubes
dyes by, for example, Azure
lubrication by, for example, PTFE
chemical and/or UV resistance by, for example, 2(2′-hydroxyphenyl)benzotriazole
   and further known effects, additives and their combinations, which are not listed. One or more additive(s) can therefore be mixed with the thermoplastic.

The coating material, in particular in powder form, can have an average particle diameter of 1 micrometers to 300 micrometers or more.

The coating is carried out by trickling, dipping, dusting or other possibilities of the coating material, such that the surface of the partially cured intermediate object is covered entirely or in sections with the coating material, in particular the powder. Numerous other coating techniques are obvious to a person skilled in the art.

The coating can be carried out using any suitable technique prior to or during the heating step, as suitable.

In some embodiments, coating is followed by a further cleaning step in order to remove excess coating material.

Curing should be understood as the process step in which the partially cured intermediate object manufactured of dual-curing resin is completely cured, for example, heat-polymerized.

The curing is carried out according to the present subject matter after the surface coating of the partially cured intermediate object, wherein a cleaning step can also be carried out between the coating and the curing.

The curing is carried out, for example, via heat polymerization of the partially cured intermediate object. The heat polymerization can be accelerated via active heating. Active heating is carried out, for example, in an oven, such as, for example, an electric oven, a gas oven, a solar oven or a microwave oven, a heated bath or a combination thereof.

Additionally or alternatively, the partially cured intermediate object can also cure by means of “passive” heating. Depending on the polyurethane resin, a low temperature is also sufficient in some cases, in order to start the heat polymerization, for example, ambient temperature or room temperature. At a low temperature, the reaction of the heat polymerization takes place slowly. It therefore takes longer until the reaction has been completed and the object is completely cured.

In general, active heating is faster than “passive” heating and is typically preferred, although passive heating, such as, for example, simply holding the partially cured intermediate product at ambient temperature for a sufficient length of time in order to bring about curing, can be used in some embodiments.

Preferably, curing by means of active heating is carried out at at least one first (oven) curing temperature and a second (oven) curing temperature, wherein the first curing temperature is greater than the ambient temperature and the second curing temperature is greater than the first curing temperature, but less than 300° C.

Active heating therefore takes place, for example, with a ramped or stepped increase between ambient temperature and the first curing temperature and/or between the first curing temperature and the second curing temperature.

One exemplary embodiment of actively heating the intermediate product is as follows:

The process starts at room temperature, followed by a ramped increase of the temperature to 140° C. within 90 minutes. The temperature is then held constant for 90 minutes. Thereafter, the heat supply is switched off and cooling takes place in the oven. At a temperature below 90° C., the oven can be opened and the product can be removed. A suitable curing process is selected depending on the materials used.

In some embodiments, the curing is carried out in an inert gas atmosphere. Ovens having an inert atmosphere are known and generally use an atmosphere in the oven chamber, which has been enriched with nitrogen, argon or carbon dioxide.

In some embodiments, the curing via active heating is preferably carried out over a time of at least 1, 2, 3 or 4 hours or more and/or according to a “ramping” plan of gradually increasing temperatures or over two or more hours. Particular heating plans can be optimized on the basis of factors such as the specific type of polyurethane resin and components, the size and shape of the objects to be heated, or the melting temperature of the coating material, in particular of the thermoplastic particles, and the like.

In one particular embodiment, a curing temperature or curing temperatures are selected for curing, which are above or at the melting point of the coating material, in particular of the thermoplastic particles. As a result, the coating material, in particular the thermoplastic coating material, melts simultaneously or nearly simultaneously with the polymerization of the uncured material, such that the coating material, in particular the thermoplastic, is partially or completely integrally incorporated into the existing network of the polymerizing material partially or completely at the molecular level As a result, a particularly tight connection of the coating with the object is made possible.

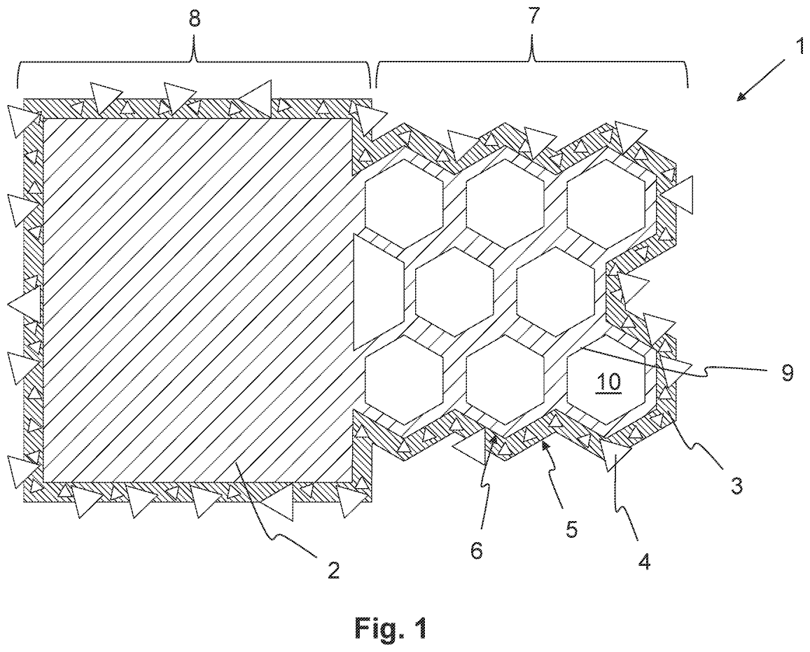

Referring now to the drawings, FIG. 1 shows a schematic sectional view of the object 1 during manufacture. The object 1 is formed from a partially cured intermediate object 2. The partially cured intermediate object 2 is formed from a dual-curable material 3 by means of an additive manufacturing method. The dual-curable material 3 is a polyurethane resin in this case.

At least some regions of the partially cured intermediate object 2 are coated with a coating material 4, in particular a pulverous coating material. In the present FIGURE, the coating material 4 is shown as small triangles. The coating material 4 can be pulverous and preferably have particle sizes between 0.001 mm and 0.3 mm. Furthermore, the coating material 4 can also be a mixture of various particle sizes. Moreover, the coating material 4 can be a thermoplastic or a thermoplastic powder.

The coating material 4 is arranged in a residual layer 5, the residual layer 5 consisting of uncured, dual-curable material. The uncured, dual-curable material, which is a polyurethane resin, can originate, for example, from the additive manufacturing method or from a first step of the additive manufacturing method. For example, the uncured, dual-curable material can also adhere to the partially cured intermediate object 2 after the partially cured intermediate object 2 is formed. Additionally or alternatively, the residual layer 5 can also be applied after the partially cured intermediate object 2 has been formed.

Additionally or alternatively, the partially cured intermediate object 2 can also be cleaned, in order to remove excess uncured, dual-curable material, such that the residual layer 5 remains. The residual layer can have a thickness between 0.001 mm and 0.1 mm. Depending on the particle size of the coating material 4 and the thickness of the residual layer 5, the coating material 4 can dip completely into the residual layer 5 or also protrude over the residual layer 5.

Furthermore, the residual layer 5 is arranged on a surface 6 of the partially cured intermediate object 2. As is apparent in FIG. 1, the residual layer 5 extends across the entire surface 6. Alternatively, portions of the residual layer 5 can also extend on the surface 6 or the residual layer 5 can be arranged in surface sections of the surface 6. This can be achieved, for example, by means of the cleaning. The residual layer 5 can be completely removed at appropriate points by means of the cleaning, such that these points are free of uncured, dual-curable material 3.

As is also apparent from FIG. 1, the object 1 and the partially cured intermediate object 2 have two sections 7, 8. In the first section 7, the object 1 or the partially cured intermediate object 2 has a strut structure. In the second section 8, the object 1 or the partially cured intermediate object 2 is formed as a solid body. In the first section 7, in which the object 1 or the partially cured intermediate object 2 has the strut structure, the coating formed from the residual layer 5 and the coating material 4 can also be arranged on the inner sides 9 of the hollow spaces 10.

After coating, the partially cured intermediate object 2 is completely cured, such that the object 1 is formed. This can be carried out by means of heating to a curing temperature. The coating material 4, when it is, for example, a thermoplastic, can melt and, during curing and/or during the polymerization of the uncured, dual-curable material 3, enter into a bonded connection with the uncured, dual-curable material 3. The coating material 4 can also be integrated into the molecular network of the uncured, dual-curable material 3. The curing temperature and/or a curing duration can be set accordingly.

The present subject matter is not limited to the exemplary embodiments which have been shown and described. Modifications within the scope of the claims are also possible, as is any combination of the features, even if they are represented and described in different exemplary embodiments.

### LIST OF REFERENCE CHARACTERS

1 object
2 partially cured intermediate object
3 dual-curable material
4 coating material
5 residual layer
6 surface
7 first section
8 second section
9 inner sides
10 hollow spaces

1-13. (canceled)

14. A method for manufacturing a coated object in which a partially cured intermediate object made of a dual-curable material is formed using an additive manufacturing method, the method comprising:
coating at least some regions of the partially cured intermediate object coated with a pulverous coating material; and
completing curing the partially cured intermediate object in a curing step such that the object is formed,
wherein a polyurethane resin is used as the dual-curable material.

15. The method of claim 14, further comprising arranging the coating material in a residual layer formed from the uncured, dual-curable material on a surface of the partially cured intermediate object.

16. The method of claim 15, wherein the uncured, dual-curable material forming the residual layer is applied on the surface during the additive manufacturing method or remains on the surface after the additive manufacturing method.

17. The method of claim 15, wherein the uncured, dual-curable material forming the residual layer is applied on the surface after the additive manufacturing method.

18. The method of claim 15, further comprising cleaning the partially cured intermediate object prior to the coating of the partially cured intermediate object with the coating material such that the residual layer formed from the uncured, dual-curable material remains.

19. The method of claim 18, wherein the cleaning of the partially cured intermediate object and/or the coating takes place after the additive manufacturing process and/or before the curing step so that the residual layer remains.

20. The method of claim 15, wherein the curing step is carried out such that a bonded connection is formed between the coating material and the uncured, dual-curable material in the residual layer.

21. The method of claim 14, wherein the additive manufacturing method is carried out using light input.

22. The method of claim 14, wherein the curing step is carried out by heating to at least one curing temperature.

23. The method of claim 22, wherein a thermoplastic is used as the coating material, which has a melting temperature that is higher than the at least one curing temperature used during the curing step.

24. The method of claim 22, wherein a thermoplastic is used as the coating material, which has a melting temperature that is equal to or less than the at least one curing temperature used during the curing step.

25. The method of claim 14, wherein the additive manufacturing method, the coating, the curing step and/or the cleaning are/is carried out multiple times.

26. The method of claim 14, wherein the curing step is carried out such that the coating material is partially or completely integrally incorporated into an existing network of the polymerizing, uncured, dual-curable material partially or completely at the molecular level.

27. An object manufactured according to the method of claim 14.

28. The object of claim 27, wherein a bonded connection or a boundary layer is formed between the coating material and the uncured, dual-curable material in a residual layer of the object.

29. The object of claim 27, wherein the object is elastic.
